(19) United States
(12) Patent Application Publication
(10) Pub. No.: US 2005/0098239 A1
(43) Pub. Date: May 12, 2005

(54) R-T-B based permanent magnet material alloy and R-T-B based permanent magnet

(75) Inventors: Futoshi Kuniyoshi, Osaka (JP); Yuji Kaneko, Osaka (JP); Hiroshi Hasegawa, Chichibu-shi (JP); Shiro Sasaki, Chichibu-shi (JP)

Correspondence Address: NIXON PEABODY, LLP, 401 9TH STREET, NW, SUITE 900, WASHINGTON, DC, 20004-2128, US

(73) Assignees: NEOMAX CO., LTD., Osaka-shi (JP); SHOWA DENKO K.K., Tokyo (JP)

(21) Appl. No.: 10/958,653

(22) Filed: Oct. 6, 2004

Related U.S. Application Data
(60) Provisional application No. 60/510,871, filed on Oct. 15, 2003.

(51) Int. Cl. H01F 1/057

(52) U.S. Cl. 148/302

(57) ABSTRACT

An R-T-B based permanent magnet material alloy according to the present invention is an alloy in the shape of a thin plate including R₂T₁₄B columnar crystals and R-rich phases (where R is at least one of the rare-earth elements including Y, T is Fe with or without at least one nonferrous transition metal element, and B is boron with or without carbon). In a structure of the alloy as viewed on an arbitrary cross section including a normal to the thin plate, the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 30%.

### BACKGROUND OF THE INVENTION

1. Field of the Invention

The present invention relates to a material alloy for an R-T-B based permanent magnet and more particularly relates to thin strips of an R-T-B based permanent magnet material alloy made by a strip casting process. The present invention further relates to an R-T-B based permanent magnet made from such an R-T-B based permanent magnet material alloy.

2. Description of the Related Art

R-T-B based permanent magnets, having the greatest maximum energy product of all permanent magnets, have such high performance as to be used in hard disks (HDs), magnetic resonance imaging (MRI) and various types of motors. In recent years, not only improvement of their thermal resistance but also fulfillment of energy saving are demanded increasingly sharply in the global market. Consequently, the permanent magnets of this type are used more and more often in motors for automobiles and other machines.

In the R-T-B based permanent magnet, R is mainly obtained by replacing a portion of Nd with another rare-earth element such as Pr or Dy and is at least one of the rare-earth elements including Y; T is obtained by replacing a portion of Fe with Co, Ni or any other transition metal; and B is boron, a portion of which may be replaced with C or N. The R-T-B based permanent magnet includes Nd, Fe and B as its main ingredients, and therefore, is often called an “Nd-Fe-B magnet” or more generally “R-Fe-B magnet”.

As used herein, the “R-T-B based permanent magnet” may refer to a magnet to which at least one element selected from the group consisting of Cu, Al, Ti, V, Cr, Ga, Mn, Nb, Ta, Mo, W, Ca, Sn, Zr and Hf is/are added either by itself or in combination. It is known that the magnetic and various other properties are improvable by adding these elements.

An R-T-B based alloy includes not only an R₂T₁₄B phase (i.e., a ferromagnetic phase contributing to magnetizing action) as a main phase but also a nonmagnetic R-rich phase having a low-melting point in which a rare-earth element is condensed. The R-T-B based alloy is an active metal, and therefore, is usually melted or cast within a vacuum or an inert gas. Also, to make a sintered magnet from a cast block of the R-T-B based alloy by a powder metallurgy process, the alloy block may be pulverized into an alloy powder with sizes of around 3 μm (as measured with a Fischer Subsieve Sizer (FSSS)), which may then be compacted under a magnetic field. Next, the powder compact, obtained by the compaction process, may be sintered at an elevated temperature of about 1,000° C. to about 1,100° C. in a sintering furnace. If necessary, the sintered body obtained in this manner is subjected to heat treatment, machining and plating for the purpose of increasing its corrosion resistance in many cases.

The R-rich phase of the R-T-B based sintered magnet plays the important roles of:
1) entering a liquid phase due to its low melting point during the sintering process, thereby contributing to increasing the density, and eventually the magnetization, of the magnet;
2) eliminating the unevenness of the grain boundary and decreasing the number of nucleation sites of inverse magnetic domains, thereby increasing the coercivity; and
3) magnetically insulating the main phase so as to increase the coercivity.

Accordingly, if the R-rich phases were not dispersed uniformly enough in the compacted magnet, then the compact could not be sintered well locally and the magnetic properties thereof might deteriorate partially. This is why it is important to dispers the R-rich phases uniformly in the compacted magnet. The dispersion of the R-rich phases in this R-T-B based sintered magnet depends heavily on the texure (strucutre) of an R-T-B based alloy as its material.

As a method of casting an R-T-B based alloy, a strip casting process (which will be simply referred to herein as an “SC process”) was developed and has been used in actual manufacturing processes. In the SC process, a molten alloy is poured onto, and rapidly quenched and solidified by, a copper roller, which is water-cooled inside, thereby obtaining thin strips with thicknesses of about 0.1 mm to about 1 mm. According to the SC process, the structure of the alloy comes to have very small sizes, and therefore, an R-T-B based alloy, having a structure where R-rich phases of very small sizes are dispersed, can be obtained. In this manner, in an alloy cast by the SC process, R-rich phases are dispersed finely. Accordingly, even in the magnet obtained by pulverizing and sintering the alloy, the R-rich phases are still dispersed uniformly enough to improve the magnetic properties of the magnet significantly (see Japanese Laid-Open Publications No. 5-222488 and No. 5-295490).

The thin strips of the alloy that has been cast by the SC process also have highly homogeneous structure. The degree of structure homogeneity may be evaluated by the crystal grain size or the dispersion state of the R-rich phases. In some alloy thin strips obtained by the SC process, a chilled structure (i.e., isometric crystals) may sometimes be produced in their portions that have been in contact with the casting roller (which will be referred to herein as “caster-side portions”). On the whole, though, an adequately fine and homogenous structure can be obtained as is normally expected from such a rapid quenching and solidification process.

As described above, the R-T-B based alloy that has been cast by the SC process has R-rich phases dispersed finely and also exhibits excellent structure homogeneity. Thus, in making a sintered magnet of such an alloy, the degree of homogeneity of the R-rich phases is increased in the resultant magnet and the magnetic properties are improved. As can be seen, the R-T-B based alloy block that has been cast by the SC process has an excellent structure that can be used effectively to make a sintered magnet. However, the higher the performance of magnets to be achieved, the higher the degree of control to be done on the structure on the material alloy (e.g., how the R-rich phases are present there, among other things).

Last year, the present inventors carried out a research on the relationship between the structure of an R-T-B based cast alloy and its behavior during a hydrogen crushing or fine pulverization process. As a result, we discovered that in order to make the particle sizes of an alloy powder for a sintered magnet uniform enough, the dispersion state of the R-rich phases should be controlled (see Japanese Laid-Open Publication No. 2003-188006). We also discovered that a caster-side portion of the alloy in which the R-rich phases were dispersed extremely finely (which will be referred to herein as a “fine R-rich phase portion”) was likely to have such small particle sizes as to decrease the pulverization stability of the alloy and to broaden the particle size distribution of the powder excessively. Thus, we discovered that that fine R-rich phase portion should be decreased to improve the performance of the magnet.

By using the alloy with a small fine R-rich phase portion as disclosed in Japanese Laid-Open Publication No. 2003-188006, the pulverization stability and magnetic properties are improvable. However, the R-rich phases cannot play their originally expected role fully just by decreasing the fine R-rich phase portions. Thus, the magnetic properties of permanent magnets need to be further improved by controlling the alloy structure even more precisely.

An object of the present invention is to provide an R-T-B based permanent magnet material alloy, which can contribute to improvement of magnetic properties by controlling the R-rich phases in the alloy on an even more microscopic scale.

### SUMMARY OF THE INVENTION

The present inventors observed R-rich phases present in an R-T-B based alloy on an even more microscopic scale to discover a significant relationship between the shapes of the R-rich phases and the magnetic properties. Specifically, the present invention is defined as follows:

(1) An R-T-B based permanent magnet material alloy in the shape of a thin plate, the alloy comprising R₂T₁₄B columnar crystals and R-rich phases (where R is at least one of the rare-earth elements including Y, T is either Fe alone or a combination of Fe and at least one transition metal element other than Fe, and B is either boron alone or boron and carbon), wherein in a structure of the alloy as viewed on an arbitrary cross section including a normal to the thin plate, the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 30%.

(2) The R-T-B based permanent magnet material alloy of (1), wherein the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 50%.

(3) The R-T-B based permanent magnet material alloy of (1), wherein the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 70%.

(4) The R-T-B based permanent magnet material alloy of one of (1) to (3), wherein the aspect ratio is 20 or more.

(5) An R-T-B based permanent magnet material alloy in the shape of a thin plate, the alloy comprising R₂T₁₄B columnar crystals and R-rich phases (where R is at least one of the rare-earth elements including Y, T is either Fe alone or a combination of Fe and at least one transition metal element other than Fe, and B is either boron alone or boron and carbon), wherein in a structure of the alloy as viewed on an arbitrary cross section including a normal to the thin plate, the ratio of the combined area of some of the R-rich phases, which have aspect ratios of 10 or more and the major axes of which define angles of at most 30 degrees or at least 150 degrees with respect to the surface of the thin plate, to the overall area of the R-rich phases included in the alloy is at most 50%.

(6) The R-T-B based permanent magnet material alloy of (5), wherein the ratio of the combined area of some of the R-rich phases, which have aspect ratios of 10 or more and the major axes of which define angles of at most 30 degrees or at least 150 degrees with respect to the surface of the thin plate, to the overall area of the R-rich phases included in the alloy is at most 30%.

(7) An R-T-B based permanent magnet material alloy in the shape of a thin plate, the alloy comprising R₂T₁₄B columnar crystals and R-rich phases (where R is at least one of the rare-earth elements including Y, T is either Fe alone or a combination of Fe and at least one transition metal element other than Fe, and B is either boron alone or boron and carbon), wherein in a structure of the alloy as viewed on an arbitrary cross section including a normal to the thin plate, the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 30%, and the ratio of the combined area of some of the R-rich phases, which have aspect ratios of 10 or more and the major axes of which define angles of at most 30 degrees or at least 150 degrees with respect to the surface of the thin plate, to the overall area of the R-rich phases included in the alloy is at most 50%.

(8) The R-T-B based permanent magnet material alloy of (7), wherein the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 50%, and the ratio of the combined area of some of the R-rich phases, which have aspect ratios of 10 or more and the major axes of which define angles of at most 30 degrees or at least 150 degrees with respect to the surface of the thin plate, to the overall area of the R-rich phases included in the alloy is at most 30%.

(9) The R-T-B based permanent magnet material alloy of one of (1) to (8), wherein the material alloy is made by a strip casting process.

(10) The R-T-B based permanent magnet material alloy of (9), wherein the material alloy has an average thickness of 0.10 mm to 0.50 mm.

(11) An R-T-B based permanent magnet made from the R-T-B based alloy of one of (1) through (10).

### BRIEF DESCRIPTION OF THE DRAWINGS

FIG. 1 shows a cross-sectional structure of an alloy thin strip for a rare-earth magnet, including aggregated R-rich phases and made by a conventional SC process.

FIG. 2 shows a cross-sectional structure of an alloy thin strip for a rare-earth magnet, including R-rich phases with high-order dendritic arms and made by the conventional SC process.

FIG. 3 shows a cross-sectional structure of an alloy thin strip for a rare-earth magnet according to the present invention.

FIG. 4 is a schematic representation of a caster for use to perform a strip casting process.

### DETAILED DESCRIPTION OF PREFERRED EMBODIMENTS

Hereinafter, preferred embodiments of an R-T-B based permanent magnet material alloy according to the present invention will be described with reference to the accompanying drawings.

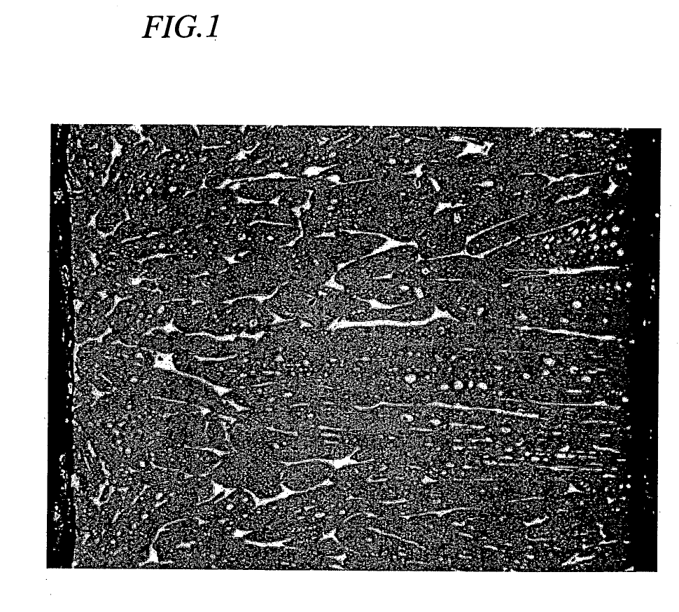

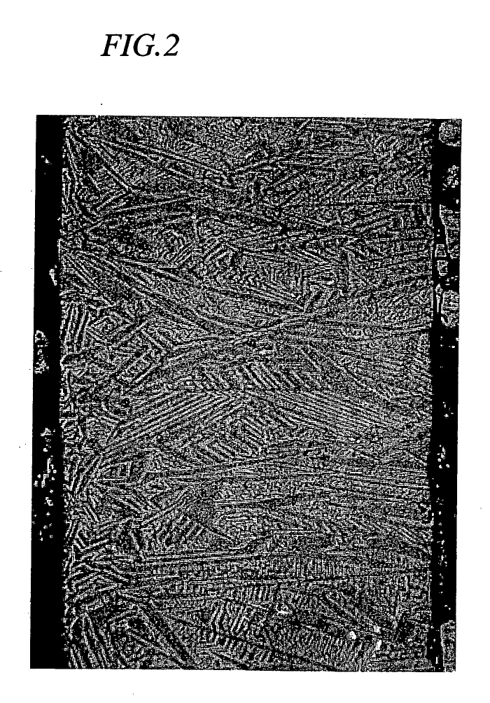

First, referring to FIGS. 1 and 2, shown are scattered electron images that were obtained by observing cross sections of an Nd-Fe-B based alloy (including 31.5 mass % of Nd) thin strip, which had been cast by a conventional SC process, with a scanning electron microscope (SEM). In both of these drawings, a portion on the left-hand side shows the caster-side portion of the alloy, while the opposite portion on the right hand side shows the free end portion of the alloy. In rapidly quenching and solidifying a molten alloy by the SC process, the molten alloy is going to be rapidly quenched and crystallized from the caster-side portion to begin with.

In FIG. 1, the white portions represent Nd-rich phases (where the R-rich phases are called as such because R is Nd in this case). As can be seen from FIG. 1, the Nd-rich phases are aggregated so as to make pools here and there. In FIG. 2 on the other hand, very small Nd-rich phases are dispersed just like dendrites.

To make a sintered magnet from an R-T-B based alloy, the R-T-B based alloy needs to be pulverized and compacted to obtain a powder compact. In pulverizing the R-T-B based alloy, the R-T-B based alloy is preferably decrepitated by a hydrogen absorption process first, and then pulverized finely. As a result of the decrepitation by the hydrogen absorption, the R-T-B based alloy is coarsely pulverized (i.e., crushed). In this process step of crushing the R-T-B based alloy with hydrogen, the alloy absorbs hydrogen through the R-rich phases so as to turn into an easily expandable hydride. Accordingly, in the hydrogen crushing process, very small cracks are created in the alloy either along or from the R-rich phases. Thereafter, in the fine pulverization process, the alloy is broken due to a lot of very small cracks that have been created by the hydrogen crushing process. For that reason, the dispersion state of the R-rich phases tended to affect the efficiency of the fine pulverization process and the shape of the finely pulverized powder. Thus, the present inventors observed the R-rich phases on an even more microscopic scale to discover that there was a correlation among the shapes of the respective R-rich phases, the very small cracks produced by the hydrogen crushing process, and the magnetic properties.

The R-rich phases scattered like pools as shown in FIG. 1 create very small cracks radially during the hydrogen crushing process and are decrepitated themselves. Accordingly, while being subjected to a jet mill pulverization process after that, most of the decrepitated and scattered R-rich phases are separated from the main phase and pulverized very finely. The very fine powder consisting of these R-rich phases is separated by a cyclone and is unlikely to be recovered, thus often causing a variation in composition during the pulverization process. In addition, the fine powder consisting of the R-rich phases is very active. Thus, when the oxygen concentration increases, the magnetic properties are likely to deteriorate and more secure measures need to be taken to guarantee safety in the manufacturing process. As a result, the manufacturing efficiency decreases and the cost increases.

On the other hand, as for the very fine dendritic R-rich phases such as those shown in FIG. 2, the gap between two adjacent fine dendritic R-rich phases is even smaller than a pulverized powder particle size for a normal sintered magnet. For that reason, an increased percentage of fine dendritic R-rich phases are introduced into the fine powder that has already been subjected to the jet mill pulverization. As described above, the R-rich phases enter the liquid phase during a sintering process and contribute to the sintering action. For that purpose, however, the R-rich phases need to be present on the surface of the respective fine powder particles and keep those fine powder particles wet during the sintering process. Nevertheless, the R-rich phases that have already entered the powder particles are no longer expected to achieve such effects. Likewise, sufficient effects could not be caused by even the R-rich phases that have leaked out on the surface. Instead, those R-rich phases would just decrease the sintered density of the magnet.

Furthermore, if there are a lot of those very fine dendritic R-rich phases, then the branched portions of the dendrites will be present inside of the powder particles and an increased percentage of R₂T₁₄B phases with different anisotropy will also be present inside of the same powder particles. As a result, the resultant permanent magnet has a decreased degree of magnetic orientations, which is a problem.

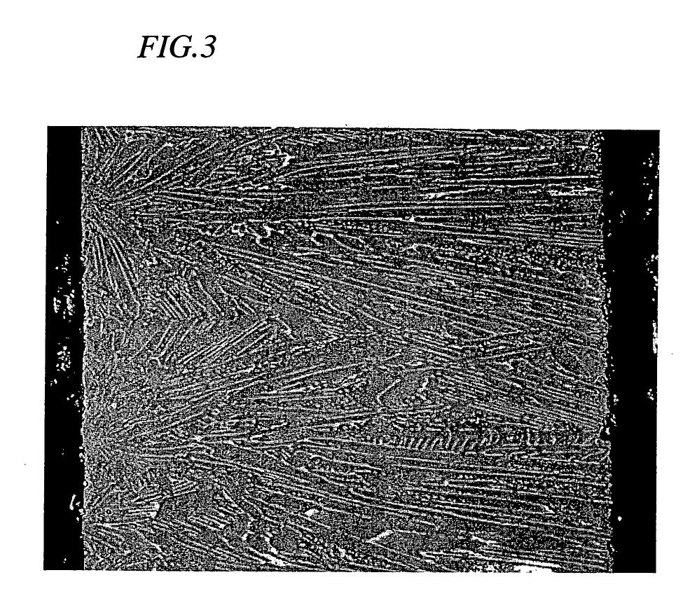

Next, an Nd—Fe—B based alloy (including 31.5 mass % of Nd) according to the present invention, which was also cast by a SC process, will be described with reference to FIG. 3, which shows a scattered electron image that was obtained by observing a cross section of an Nd-Fe-B cast alloy strip according to the present invention with a scanning electron microscope (SEM).

As can be seen from FIG. 3, a dominating percentage of the Nd-rich phases on this cross-sectional photograph extend as lamellar phases within a limited angular range around the center of thickness of the alloy. The scattered R-rich phases such as those shown in FIG. 1 and the dendritic R-rich phases such as those shown in FIG. 2 are also present just in very small percentages. If an alloy with such a structure is pulverized into a fine powder by a hydrogen crushing process and then a jet mill pulverization process, then the problems of the alloys having the structures shown in FIGS. 1 and 2, i.e., variation in composition, deterioration of magnetic properties due to increase in the concentration of oxygen or nitrogen, decrease in sintered density, and decrease in the degree of magnetic orientations, can be overcome. As a result, a material alloy, which can be used as a best material for an R-T-B based permanent magnet by making the R-rich phases function just as expected, can be obtained. And by using such a material alloy, an R-T-B based permanent magnet with high magnetic properties is realized.

Even in a conventional R-T-B based alloy, there is a structure such as that shown in FIG. 3 just partially. Also, Japanese Laid-Open Publications Nos. 09-170055 and 10-36949 disclose that the dispersion state of the R-rich phases in an R-T-B based alloy can be controlled by adjusting the cooling rate of the melt solidified during a casting process or by a heat treatment. However, even if a structure such as that shown in FIG. 3 is partially present in a conventional R-T-B based alloy, the majority of the alloy still consists of the structures shown in FIGS. 1 and 2. Consequently, the R-rich phases cannot play their originally expected role fully.

Hereinafter, an R-T-B based permanent magnet material alloy according to the present invention will be described in detail.

(1) Strip Casting Process

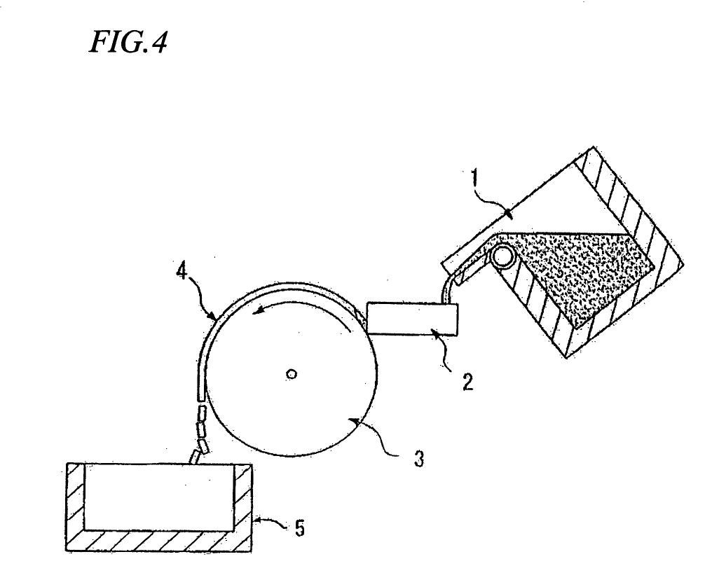

First, it will be described with reference to FIG. 4 how to cast an R-T-B based permanent magnet material alloy by a strip casting process. FIG. 4 is a schematic representation illustrating a caster for use to perform a strip casting process.

An R-T-B based alloy is a chemically active material and is usually melted in a refractory crucible 1 within either a vacuum or an inert gas atmosphere. The molten alloy is maintained at a temperature of 1,300° C. to 1,500° C. for a predetermined amount of time, and then fed onto a casting chill roller 3, which is cooled with water inside, by way of a tundish 2, which may be provided with a rectifier mechanism or a slug removing mechanism if necessary.

The melt feeding rate and the rotational velocity of the chill roller are appropriately controlled according to the thickness of the alloy to be obtained. The circumferential velocity of the rotating chill roller is preferably defined within the range of about 0.5 m/s to about 3 m/s. The material of the casting chill roller is preferably copper or a copper alloy because copper or its alloy has a good thermal conductivity and is easily available. However, depending on the material or the surface state of the chill roller, a metal might easily deposit itself on the surface of the casting chill roller. Thus, by providing a cleaner when needed, the quality of the R-T-B based alloy being cast can be stabilized. The alloy 4 that has been solidified on the chill roller leaves the roller from the opposite side of the roller for the tundish and then is collected in a collecting container 5. If a heating/cooling mechanism is provided for this container, the structure state of the R-rich phases can be-controlled.

In making an alloy according to the present invention, the cooling process on the casting roller (which will be referred to herein as a “primary cooling process”) and the cooling process in the collecting container (which will be referred to herein as a “secondary cooling process”) need to be controlled appropriately.

More specifically, the primary cooling process is carried out to decrease the temperature of the alloy that is going to leave the casting roller to somewhere between 600° C. and 850° C. The temperature of the alloy that is about to leave the casting roller needs to be higher than the melting point of the R-rich phases, which is normally 600° C. or more although the temperature varies to a certain extent depending on the composition. Suppose the temperature of the alloy that is about to leave the casting roller were lower than the melting point of the R-rich phases. In that case, a structure such as that shown in FIG. 2 would be obtained because the R-rich phases have already been solidified. On the other hand, if the alloy temperature at that point in time exceeded 850° C., then the R-rich phases would aggregate like pools here and there to form a structure such as that shown in FIG. 1 after the alloy has left the roller. The temperature of the alloy that is going to leave the casting roller more preferably falls within the range of 600° C. to 800° C., even more preferably within the range of 640° C. to 750° C. It should be noted that these preferred temperature ranges are somewhat variable according to the composition of the alloy.

The dispersion state and shapes of the R-rich phases heavily depend on the total rare-earth content (TRE). For example, as for an alloy with a low TRE (i.e., including the R-rich phases at a small percentage), the quantity of heat removed from that alloy on the casting roller is relatively small, and therefore, the alloy that is going to leave the casting roller tends to have a rather high temperature. As a result, the R-rich phases are more likely to aggregate and make pools here and there. On the other hand, as for an alloy with a high TRE (i.e., including the R-rich phases at a high percentage), the quantity of heat removed from that alloy on the casting roller is relatively large, and therefore, the alloy is more likely to produce a structure with high-order dendrite arms. Accordingly, to control the temperature of the alloy that is about to leave the casting roller within the preferred ranges mentioned above, the alloy needs to be relatively thin if the TRE thereof is low but relatively thick if the TRE thereof is high. More specifically, if the target TRE is less than 30 wt %, then the average thickness of the alloy is preferably 0.10 mm to 0.30 mm, more preferably 0.15 mm to 0.27 mm, and even more preferably 0.20 mm to 0.25 mm, to increase the degree of primary cooling. On the other hand, if the target TRE is 30 wt % to 33 wt %, then the average thickness of the alloy is preferably 0.25 mm to 0.35 mm and more preferably 0.26 mm to 0.32 mm. Furthermore, if the target TRE is more than 33 wt %, then the average thickness of the alloy is preferably 0.28 mm to 0.50 mm and more preferably 0.28 mm to 0.35 mm.

Alternatively, the degree of primary cooling may also be controlled by appropriately setting the surface roughness of the casting roller and adjusting the quantity of heat removed from the alloy on the casting roller. This method is particularly effective if the target TRE is less than 30 wt % or more than 33 wt %. By increasing the surface roughness of the casting roller, excessive heat removal can be avoided. If the TRE is more than 33 wt %, the quantity of heat that would be transferred in profusion from a lot of R-rich phases to the casting roller can be reduced appropriately by roughening the surface of the casting roller. In this case, the target surface roughness would be represented by a ten-point average roughness Rz of 20 μm or more. On the other hand, if the TRE is 30 wt % or less, then the surface roughness is preferably about 20 μm or less so as not to interfere with the primary cooling on the roller and to prevent the R-rich phases from aggregating excessively. It should be noted, however, that the surface roughness is also affected by other factors such as the surface material of the roller and are not necessarily limited to these values.

The surface temperature of the casting roller affects the wettability of the molten alloy to the roller. Specifically, if the temperature were too low, then the wettability of the molten alloy to the roller would decrease so much as to create non-uniformity in their contact macroscopically. As a result, a temperature distribution would be created in the alloy, thus deviating the actual temperature of the alloy from the preferred temperature ranges of the alloy that is going to leave the casting roller described above. Consequently, it becomes difficult to produce R-rich phases having the particular shape of the present invention. Meanwhile, if the temperature were too high, then the wettability of the molten alloy to the roller would increase so much as to produce partial seizure sometimes. If the alloy stuck to the surface of the roller, then the heat transfer and the wettability would vary significantly there, thus causing a variation in the alloy structure. Consequently, it also becomes difficult to produce R-rich phases having the particular shape of the present invention. Also, when the amount of the sticking alloy further increased, the work could not be done with good stability and the productivity would drop. In view of these considerations, the surface temperature of the casting roller should fall within the range of 50° C. to 400° C., and is preferably 100° C. to 300° C. and more preferably 150° C. to 200° C. In this case, the surface temperature of the roller is estimated where the melt contacts with the roller. It is difficult to measure that temperature directly. However, it can be calculated from the value obtained by either a thermocouple embedded right under the casting surface or a thermocouple provided on the surface of the roller so as not to contact with the alloy or the melt (e.g., on the lower portion of the tundish).

Meanwhile, the secondary cooling can be done effectively by controlling the cooling rate of the collected alloy with partitions provided in the collecting container at appropriately adjusted intervals and with the partitions cooled inside with an inert gas such as Ar. In making the alloy of the present invention, if the temperature of the alloy collected in the collecting container is 650° C. to 700° C., then the alloy is preferably cooled to 600° C. at a rate of 3° C./min to 30° C./min, more preferably at a rate of 3° C./min to 20° C./min. On the other hand, if the temperature of the alloy collected in the collecting container is 700° C. to 800° C., then the alloy is preferably cooled to 600° C. at a rate of 10° C./min to 40° C./min, more preferably at a rate of 10° C./min to 30° C./min. Furthermore, if the temperature of the alloy collected in the collecting container is 800° C. to 850° C., then the alloy is preferably cooled to 600° C. at a rate of 20° C./min to 50° C./min, more preferably at a rate of 30° C./min to 50° C./min. If the upper limit of any of these temperature ranges were exceeded, then a structure such as that shown in FIG. 2 would be produced easily. Also, if the lower limit of any of these temperature ranges were not reached, then a structure such as that shown in FIG. 1 would be produced easily.

It should be noted that according to the present invention, the structure of the alloy is defined clearly but the method of making the alloy is not limited to the above method.

The alloy thin strips of the present invention preferably have a thickness of 0.1 mm to 0.5 mm. The reasons a r e as follows. Specifically, if the thickness of the alloy thin strips were less than 0.1 mm, then the solidification rate would increase so much that the R-rich phases would be dispersed too finely. On the other hand, if the thickness of the alloy thin strips were more than 0.5 mm, then the solidification rate would decrease too much to dispers the R-rich phases uniformly enough.

(2) R-Rich Phases in the Alloy

The present invention provides an R-T-B based permanent magnet material alloy in the shape of a thin plate, which includes R₂T₁₄B columnar crystals and R-rich phases (where R is at least one of the rare-earth elements including Y, T is either Fe alone or a combination of Fe and at least one transition metal element other than Fe, and B is either boron alone or boron and carbon). And in a structure of the alloy as viewed on an arbitrary cross section including a normal to the thin plate, the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 30%. As a result, a material alloy, which can be used as a best material for an R-T-B based permanent magnet, can be obtained by making the R-rich phases function just as expected almost without causing a variation in composition, deterioration of magnetic properties due to increase in the concentration of oxygen or nitrogen, decrease in sintered density, or decrease in the degree of magnetic orientations during a fine pulverization process step in the process of making a sintered magnet. Also, by using such a material alloy, an R-T-B based permanent magnet with high magnetic properties is realized.

If the R-rich phases in the alloy have aspect ratios of less than 10, then the R-rich phases are scattered as aggregated pools. And when the percentage of such R-rich phases increases, more and more R-rich phases will either drop or pulverized so finely during the pulverization process as to cause a significant variation in composition.

Furthermore, even if the aspect ratios of the R-rich phases were 10 or more but if the major axes thereof defined angles exceeding the range of 90±30 degrees with respect to the surface of the thin plate, then it would be rather probable that the R-rich phases are dendritic with excessively narrow gaps. Such R-rich phases are generally labeled as “high-order dendrites” metallographically. As for an actual alloy structure, however, different people often have different opinions in telling first-order dendrites from second- and higher-order dendrites. Thus, the geometric definition is adopted herein to set this range.

As a result, the present inventors discovered that when the ratio of the combined area of some of the R-rich phases, which had aspect ratios of 10 or more and the major axes of which defined angles of 90±30 degrees with respect to the surface of the thin plate, to the overall area of the R-rich phases included in the alloy was 30% or less, the magnetic properties deteriorated significantly.

Preferably, the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 50%. More preferably, the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 70%.

More preferably, the aspect ratios are 20 or more in the alloy described above. Even more preferably, the aspect ratios are 30 or more in the alloy described above.

Alternatively, the ratio of the combined area of some of the R-rich phases, which have aspect ratios of 10 or more and the major axes of which define angles of at most 30 degrees or at least 150 degrees with respect to the surface of the thin plate, to the overall area of the R-rich phases included in the alloy may be at most 50%. It is highly probable that those R-rich phases, which have aspect ratios of 10 or more but the major axes of which define angles of at most 30 degrees or at least 150 degrees with respect to the surface of the thin plate, are high-order dendritic arms with narrow gaps.

Preferably, the ratio of the combined area of some of the R-rich phases, which have aspect ratios of 10 or more and the major axes of which define angles of at most 30 degrees or at least 150 degrees with respect to the surface of the thin plate, to the overall area of the R-rich phases included in the alloy is at most 30%.

Alternatively, the ratio of the combined area of some of the R-rich phases, which have aspect ratios of 10 or more and the major axes of which define angles of 90±30 degrees with respect to the surface of the thin plate, to the overall area of the R-rich phases included in the alloy may be at least 30%, and the ratio of the combined area of some of the R-rich phases, which have aspect ratios of 10 or more and the major axes of which define angles of at most 30 degrees or at least 150 degrees with respect to the surface of the thin plate, to the overall area of the R-rich phases included in the alloy may be at most 50%.

Preferably, the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 50%, and the ratio of the combined area of some of the R-rich phases, which have aspect ratios of 10 or more and the major axes of which define angles of at most 30 degrees or at least 150 degrees with respect to the surface of the metal, to the overall area of the R-rich phases included in the alloy is at most 30%.

In the R-rich phases having aspect ratios of 10 or more as described above, R-rich phases having aspect ratios of 20 or more, and R-rich phases having aspect ratios of 30 or more, the major axis sizes thereof are preferably at least 5%, more preferably at least 10%, of the thickness of the thin plate.

The R-rich phases have higher backscattered electron intensity (BEI) than the main phase. Accordingly, the aspect ratios of the R-rich phases in the alloy, the angles defined by their major axes with respect to the surface of the thin plate, and the area ratio of those R-rich phases can be obtained by identifying the main phase and R-rich phases from each other with an image analyzer. For example, photos of 10 randomly selected cross sections of the alloy thin strip may be taken with the BEIs measured at an appropriate power of magnification. In each of these 10 photos, the overall area of the R-rich phases included in the photo and the combined area of some of the R-rich phases, which have predetermined aspect ratios and the major axes of which define angles falling within a certain angular range, are calculated through an image analysis process. Then, the respective combined areas of the R-rich phases, which have predetermined aspect ratios and the major axes of which define angles falling within a certain angular range, are added together, the respective overall areas of the R-rich phases appearing on the 10 photos are also added together, and the former sum is divided by the latter sum, thereby obtaining the area ratio of predetermined R-rich phases.

(3) R₂T₁₄B Phase in the Alloy

An R-T-B based permanent magnet material alloy in the shape of a thin plate according to the present invention includes a ferromagnetic R₂T₁₄B phase as its main phase. The R₂T₁₄B phases are dispersed as columnar crystals. And the R₂T₁₄B columnar crystals preferably have major axes that define angles of 90±30 degrees with respect to the surface of the thin plate. Also, the major-axis lengths thereof are preferably at least 30%, more preferably at least 50%, of the thickness of the thin plate. Furthermore, those preferred R₂T₁₄B columnar crystals preferably account for at least 30%, more preferably at least 50%, of all R₂T₁₄B columnar crystals included in the entire thin plate.

In this case, the R₂T₁₄B columnar crystals refer to blocks with aligned crystallographic orientations as observed with a polarizing microscope by utilizing magnetic Kerr effects.

Hereinafter, specific examples of the present invention and comparative examples will be described.

### EXAMPLE NO. 1

Metal neodymium, ferroboron, cobalt, aluminum, copper and iron were mixed together so that the resultant alloy would have a composition including 31.5 mass % of Nd, 1.00 mass % of B, 1.0 mass % of Co, 0.30 mass % of Al, 0.10 mass % of Cu and iron as the balance. The mixture was melted in an induction heating melting crucible, and the melt was cast by a strip casting process, thereby obtaining alloy thin strips.

The casting chill roller had a diameter of 300 mm, was made of pure copper with a thickness of 50 mm, and was cooled with water inside. By rotating this roller at a circumferential velocity of 1.0 m/s during the casting process, alloy thin strips with an average thickness of 0.27 mm were obtained. At that time, the surface of the casting roller had an average roughness Rz of 12 μm. When viewed with the eyes, the alloy was running uniformly on the casting roller and no sticking on the casting roller was observed.

Also, a thermocouple was brought into contact with the bottom of the surface of the casting roller, thereby measuring the surface temperature of the casting roller during the casting process. In addition, the quantity of the cooling water for cooling the casting roller, the difference in temperature between the incoming water and outgoing water, and the temperature of the water drained from the casting roller were measured. Based on these measured values, the surface temperature of the casting roller where the melt poured from the tundish contacted with the casting roller was calculated to be 170° C.

Also, the temperature of the alloy thin strips that had left the roller was measured 730° C. with an infrared thermometer. In the collecting container to store the alloy thin strips, partitions, in which an Ar gas was circulated for cooling purposes, were provided. Another thermocouple was inserted into the collecting container through a side surface thereof so as to measure a variation in the temperature of the alloy. As a result, the maximum temperature was 720° C. and the average cooling rate was 22° C./min until the temperature of the alloy reached 600° C.

Ten of those alloy thin strips obtained were embedded and ground. Thereafter, a backscattered electron image (BEI) of each alloy thin strip was taken with a scanning electron microscope (SEM) at a power of magnification of 100. The photo taken was fed into an image analyzer so that the alloy thin strip was subjected to measurements. As a result, the ratio of the combined area of R-rich phases, which had aspect ratios of 10 or more and the major axes of which defined angles of 90±30 degrees with respect to the surface of the metal, to the overall area of the R-rich phases included in the alloy was 80%. Also, the ratio of the combined area of R-rich phases, which had aspect ratios of 20 or more and the major axes of which defined angles of 90±30 degrees with respect to the surface of the metal, to the overall area of the R-rich phases included in the alloy was 65%. On the other hand, the ratio of the combined area of R-rich phases, which had aspect ratios of 10 or more and the major axes of which defined angles of at most 30 degrees or at least 150 degrees with respect to the surface of the metal, to the overall area of the R-rich phases included in the alloy was 6%.

### COMPARATIVE EXAMPLE NO. 1

The same materials were mixed together so that the resultant alloy had the same composition as that described for the first specific example of the present invention. Then, the mixture was melted and the melt was cast by the SC process as in the first specific example, too. In this comparative example, however, the casting roller had a thickness of 90 mm, the average roughness Rz on the surface of the casting roller was 7 μm and the alloy thin strips had an average thickness of 0.35 mm. When the alloy thin strips were viewed with the eyes, a few portions of the alloy on the casting roller had abnormally high temperatures and some stuck to the roller.

When measured by the same method as that adopted for the first specific example, the surface temperature of the casting roller where the melt that was poured from the tundish contacted with the casting roller was 400° C.

Also, the temperature of non-sticking alloy thin strips that had left the roller was measured 820° C. with an infrared thermometer. In the collecting container to store the alloy thin strips that had left the roller, no special cooling mechanism was provided. The variation in the temperature of the alloy was measured with a thermocouple that was inserted into the collecting container through a side surface thereof. As a result, the maximum temperature was 810° C. and the average cooling rate was 6° C./min until the alloy temperature reached 600° C.

Those non-sticking alloy thin strips were evaluated as in the first specific example described above. As a result, many of the R-rich phases aggregated together to form pools here and there. Consequently, the ratio of the combined area of R-rich phases having aspect ratios of 10 or more to the overall area of all R-rich phases included in the alloy was 26%.

### COMPARATIVE EXAMPLE NO. 2

The same materials were mixed together so that the resultant alloy had the same composition as that described for the first specific example of the present invention. Then, the mixture was melted and the melt was cast by the SC process as in the first specific example, too. In this comparative example, however, the casting roller had a thickness of 25 mm, the average roughness Rz on the surface of the casting roller was 10 μm and the alloy thin strips had an average thickness of 0.22 mm. When the alloy thin strips were viewed with the eyes, some portions of the alloy on the casting roller had somewhat high temperatures.

When measured by the same method as that adopted for the first specific example, the surface temperature of the casting roller where the melt that was poured from the tundish contacted with the casting roller was 80° C.

Also, the average temperature of the alloy thin strips that had left the roller was measured 670° C. with an infrared thermometer. In the collecting container to store the alloy thin strips that had left the roller, partitions, in which cooling water was circulated, were provided. The variation in the temperature of the alloy was measured with a thermocouple that was inserted into the collecting container through a side surface thereof. As a result, the maximum temperature was 660° C. and the average cooling rate was 35° C./min until the alloy temperature reached 600° C.

Those resultant alloy thin strips were evaluated as in the first specific example described above. As a result, the R-rich phases included a lot of high-order dendrites. The ratio of the combined area of some of the R-rich phases, which had aspect ratios of 10 or more and the major axes of which defined angles of 90±30 degrees with respect to the surface of the metal, to the overall area of the R-rich phases included in the alloy was 23%. On the other hand, the ratio of the combined area of some of the R-rich phases, which had aspect ratios of 10 or more and the major axes of which defined angles of at most 30 degrees or at least 150 degrees with respect to the surface of the metal, to the overall area of the R-rich phases included in the alloy was 54%.

Hereinafter, specific examples of a sintered magnet will be described.

### EXAMPLE NO. 2

The alloy thin strips, obtained by the first specific example described above, were coarsely pulverized by a hydrogen pulverization process. 0.07 mass % of zinc stearate powder was added to the resultant coarsely pulverized powder and these powders were mixed together with a rocking mixer within a nitrogen atmosphere. Thereafter, the mixture was finely pulverized with a jet mill machine. The jet mill pulverization was carried out within a nitrogen atmosphere to which 10,000 ppm of oxygen was added. The resultant powder had an oxygen concentration of 5,000 ppm. Then, the powder was compounded with a cold embedded resin. And the compound was cured, ground, and a cross section of the resultant powder was subjected to an SEM-BEI observation, thereby analyzing the dispersion state of the R-rich phases in the powder. As a result, it was discovered that the R-rich phases were deposited on the surface of particles consisting essentially of main phases.

Next, the resultant powder was compacted with a pressure of 1.0 t/cm² under an aligning magnetic field of 1.5 T. Then, the compact was sintered by being kept heated at 1,060° C. for four hours. The resultant sintered body had a sintered density of 7.5 g/cm³ or more, which was sufficiently high. Thereafter, this sintered body was further thermally treated at 560° C. for one hour within an argon atmosphere, thereby obtaining a sintered magnet.

The magnetic properties of this sintered magnet were measured with a BH curve tracer. The results are shown in Table 1.

### COMPARATIVE EXAMPLE NO. 3

The alloy thin strips obtained by the first comparative example described above were pulverized by the same method as that adopted for the second specific example, thereby obtaining a fine powder. At that point in time, a cross section of the powder was observed by the same method as that adopted for the second specific example. As a result, the present inventors confirmed that the majority of the R-rich phases had separated themselves from the main phases and were present as relatively small particles consisting essentially of the R-rich phases only. The powder was further subjected to the same compacting and sintering processes as those carried out for the second specific example, thereby making a sintered magnet.

The magnetic properties of the sintered magnet obtained by this third comparative example were measured with a BH curve tracer. The results are also shown in Table 1.

### COMPARATIVE EXAMPLE NO. 4

The alloy thin strips obtained by the second comparative example described above were pulverized by the same method as that adopted for the second specific example, thereby obtaining a fine powder. At that point in time, a cross section of the powder was observed by the same method as that adopted for the second specific example. As a result, the present inventors confirmed that the percentage of particles including the R-rich phases inside was about seven times as high as in the second specific example. The powder was further subjected to the same compacting and sintering processes as those carried out for the second specific example, thereby making a sintered magnet.

The magnetic properties of the sintered magnet obtained by this fourth comparative example were measured with a BH curve tracer. The results are also shown in Table 1.

TABLE 1

| | | | | | | O₂ |
|---|---|---|---|---|---|---|
| | Density | Br | iHc | (BH)max | TRE | content |
| | (g/cm³) | (T) | (kA · m) | (kJ/m³) | (mass %) | (ppm) |
| Example 2 | 7.55 | 1.39 | 1194 | 362 | 31.2 | 5500 |
| Compara- | 7.48 | 1.37 | 1098 | 344 | 30.6 | 5400 |
| tive | | | | | | |
| Example 3 | | | | | | |
| Compara- | 7.52 | 1.37 | 1154 | 352 | 31.1 | 5500 |
| tive | | | | | | |
| Example 4 | | | | | | |

where the TRE and O₂ content are those contained in a sintered magnet.

As shown in Table 1, the third comparative example had a lower density, and exhibited lower magnetization and coercivity, than the second specific example. This is probably because the R-rich phases were not dispersed so uniformly in the alloy, and would have been separated as active tiny fine powder particles by the cyclone of the pulverizer during the pulverization process, thus decreasing the TRE easily. This should also be because the R-rich phases segregated would have decreased the sinterability and could not have worked effectively enough during the sintering process. On the other hand, the fourth comparative example also behaved similarly although the degree of deterioration was lighter than the third comparative example. Thus, it is believed that the R-rich phases could not have contributed to the sintering process sufficiently, either.

As described above, by using the R-T-B based permanent magnet material alloy of the present invention, the R-rich phases included in the alloy can be made full use of. Thus, a sintered magnet made from this alloy exhibits superior magnet performance to a conventional one. That is to say, since the R-rich phases work sufficiently effectively just as expected, various beneficial effects, which could not be achieved by a conventional alloy, are obtained. Specifically, there is a little variation in composition, if ever, during the fine pulverization of the sintered magnet manufacturing process, the magnetic properties do not deteriorate easily due to the increase in oxygen concentration, and neither the sintered density nor the degree of magnetic orientations decreases. In addition, by using this material alloy, an R-T-B based permanent magnet with excellent magnetic properties can be obtained.

The present invention is effectively applicable for use in various types of electronic equipment or electromechanical systems that need high-performance sintered magnets.

1. An R-T-B based permanent magnet material alloy in the shape of a thin plate, the alloy comprising R₂T₁₄B columnar crystals and R-rich phases (where R is at least one of the rare-earth elements including Y, T is either Fe alone or a combination of Fe and at least one transition metal element other than Fe, and B is either boron alone or boron and carbon),
wherein in a structure of the alloy as viewed on an arbitrary cross section including a normal to the thin plate, the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 30%.

2. The R-T-B based permanent magnet material alloy of claim 1, wherein the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 50%.

3. The R-T-B based permanent magnet material alloy of claim 1, wherein the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 70%.

4. The R-T-B based permanent magnet material alloy of one of claims 1 to 3, wherein the aspect ratio is 20 or more.

5. An R-T-B based permanent magnet material alloy in the shape of a thin plate, the alloy comprising R₂T₁₄B columnar crystals and R-rich phases (where R is at least one of the rare-earth elements including Y, T is either Fe alone or a combination of Fe and at least one transition metal element other than Fe, and B is either boron alone or boron and carbon),
wherein in a structure of the alloy as viewed on an arbitrary cross section including a normal to the thin plate, the ratio of the combined area of some of the R-rich phases, which have aspect ratios of 10 or more and the major axes of which define angles of at most 30 degrees or at least 150 degrees with respect to the surface of the thin plate, to the overall area of the R-rich phases included in the alloy is at most 50%.

6. The R-T-B based permanent magnet material alloy of claim 5, wherein the ratio of the combined area of some of the R-rich phases, which have aspect ratios of 10 or more and the major axes of which define angles of at most 30 degrees or at least 150 degrees with respect to the surface of the thin plate, to the overall area of the R-rich phases included in the alloy is at most 30%.

7. An R-T-B based permanent magnet material alloy in the shape of a thin plate, the alloy comprising R₂T₁₄B columnar crystals and R-rich phases (where R is at least one of the rare-earth elements including Y, T is either Fe alone or a combination of Fe and at least one transition metal element other than Fe, and B is either boron alone or boron and carbon),
wherein in a structure of the alloy as viewed on an arbitrary cross section including a normal to the thin plate, the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 30%, and the ratio of the combined area of some of the R-rich phases, which have aspect ratios of 10 or more and the major axes of which define angles of at most 30 degrees or at least 150 degrees with respect to the surface of the thin plate, to the overall area of the R-rich phases included in the alloy is at most 50%.

8. The R-T-B based permanent magnet material alloy of claim 7, wherein the ratio of the combined area of some of the R-rich phases, which have aspect ratios of 10 or more and the major axes of which define angles of 90±30 degrees with respect to the surface of the thin plate, to the overall area of the R-rich phases included in the alloy is at least 50%, and the ratio of the combined area of some of the R-rich phases, which have aspect ratios of 10 or more and the major axes of which define angles of at most 30 degrees or at least 150 degrees with respect to the surface of the thin plate, to the overall area of the R-rich phases included in the alloy is at most 30%.

9. The R-T-B based permanent magnet material alloy of claim 1, 5 or 7, wherein the material alloy is made by a strip casting process.

10. The R-T-B based permanent magnet material alloy of claim 9, wherein the material alloy has an average thickness of 0.10 mm to 0.50 mm.

11. An R-T-B based permanent magnet made from the R-T-B based permanent magnet material alloy of claim 1, 5 or 7.
